(19) United States
(12) Patent Application Publication
(10) Pub. No.: US 2007/0087678 A1
(43) Pub. Date: Apr. 19, 2007

(54) System, method, and apparatus for air flow distribution in an automotive vehicle

(75) Inventor: Robert H. Tigner, Dalworthington Gardens, TX (US)

Correspondence Address: BRACEWELL & GIULIANI LLP, P.O. Box 61389, HOUSTON, TX, 77208-1389, US

(73) Assignee: SCS Frigette

(21) Appl. No.: 11/252,705

(22) Filed: Oct. 18, 2005

(51) Int. Cl. B60H 1/24

(52) U.S. Cl. 454/94

(57) ABSTRACT

A system for distributing air flow in an automotive ventilation system is disclosed. A blower is attached to a plenum assembly having multiple distribution chambers for distributing the air flow to different parts of the vehicle. A single duct channel is mounted inside the plenum between the blower and the chambers. Only the channel is pivoted to distribute the air flow to the various chambers. The system is installed in an automobile vehicle to direct air flow to, for example, the windshield, the dashboard vents, and the floor. The channel has first, second, and third positions such that it is substantially aligned with the first, second, and third chambers. The channel also has alternate positions wherein the air flow is distributed to more than one chamber at the same time.

### BACKGROUND OF THE INVENTION

1. Technical Field

The present invention relates in general to ventilation in automobiles and, in particular, to an improved system, method, and apparatus for an automotive ventilation plenum that distributes ventilated, air conditioned, and heated air with a single duct channel.

2. Description of the Related Art

Almost every automotive vehicle includes a heating, ventilation, and air condition (HVAC) system for improving the environment and comfort of occupants inside the vehicle. The distribution of the air flow or ventilation inside the vehicle is typically manipulated by extensive duct work and multiple doors and other devices for redirecting the air flow according to the desires of the vehicle occupants. Although these prior art designs are workable, they are typically complicated and may require numerous moving parts. An improved design for efficiently and effectively distributing air flow in an automotive vehicle that reduces the number of moving parts and increases a reliability of the system would be desirable.

### SUMMARY OF THE INVENTION

One embodiment of a system, method, and apparatus for distributing air flow in an automotive ventilation system is disclosed. A blower is attached to a plenum assembly having multiple distribution chambers for distributing the air flow to different parts of the vehicle. A single duct channel is mounted inside the plenum between the blower and the chambers. Only the channel is pivoted to distribute the air flow to the various chambers. The system is installed in an automobile vehicle to direct air flow to, for example, the windshield, the dashboard vents, and the floor. In one embodiment, the channel has first, second, and third positions wherein it is substantially aligned with the first, second, and third chambers. The channel also has alternate positions wherein the air flow is distributed to multiple ones of the chambers.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is an exploded isometric view of one embodiment of a ventilation distribution system constructed in accordance with the present invention;

FIG. 2 is a sectional side view of the ventilation distribution system of FIG. 1 illustrating a first position for a duct channel;

FIG. 3 is a sectional side view of the ventilation distribution system of FIG. 1 illustrating a second position for the duct channel;

FIG. 4 is a sectional side view of the ventilation distribution system of FIG. 1 illustrating a third position for the duct channel;

FIG. 5 is a sectional side view of the ventilation distribution system of FIG. 1 illustrating a fourth position for the duct channel;

FIG. 6 is a sectional side view of the ventilation distribution system of FIG. 1 illustrating a fifth position for the duct channel; and

FIG. 7 is a schematic isometric view of the ventilation distribution system of FIG. 1 shown installed in an automobile.

### DETAILED DESCRIPTION OF THE INVENTION

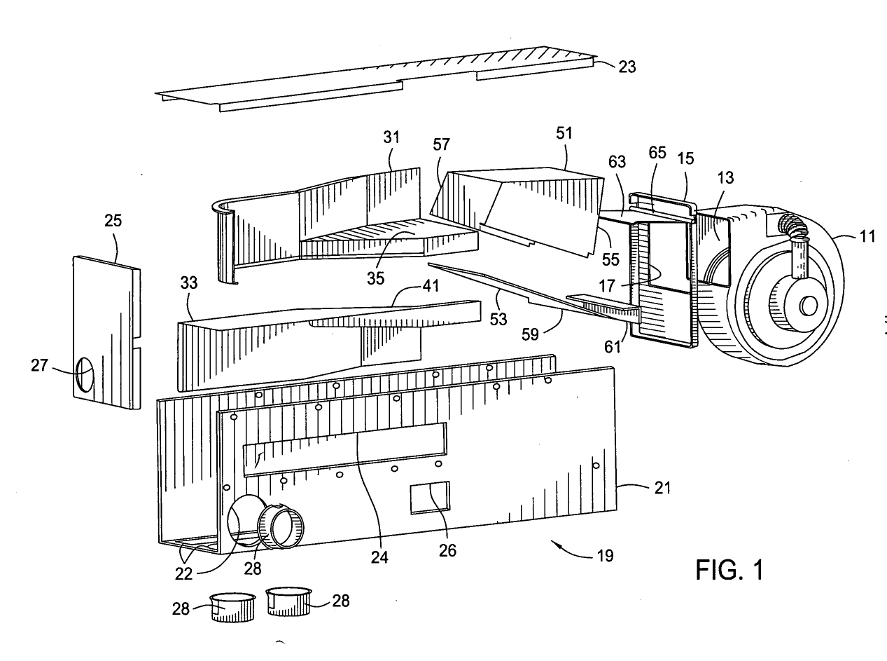

Referring to FIGS. 1-7, one embodiment of a system, apparatus, and method for distributing air flow in an automotive ventilation system is disclosed. The present invention is well suited for efficiently and reliably distributing ventilated, air conditioned, and/or heated air with a single duct channel.

As best shown in the exploded view of FIG. 1, one embodiment of the present invention utilizes a blower 11 for circulating air flow. The blower 11 has an outlet 13, and a mount plate 15 having an aperture 17 that aligns with outlet 13. The mount plate 15 also acts as an end cover for one end of a plenum assembly 19. The plenum assembly 19 includes a body 21 that forms the bottom and two side walls thereof. The body 21 includes various ports 22, 24, 26 for releasing air flow therefrom. Optional hose collars 28 may be mounted to ports 22. A top cover 23 is mounted to the upper ends of the side walls of body 21, and an end plate 25 covers the other end of the body 21 opposite mount plate 15. One or more ports 27 are formed in end plate 25 for releasing air flow therefrom.

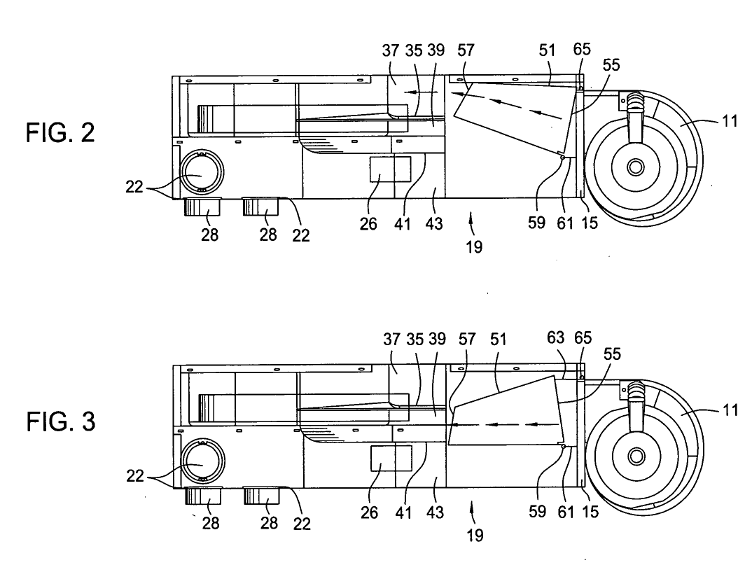

One embodiment of the plenum assembly 19 also comprises one or more baffles 31, 33 to distribute air flow therethrough. Upper baffle 31 includes a partition 35 that divides a portion of an interior volume of plenum assembly 19 into independent first and second chambers 37, 39 (FIG. 2). First chamber 37 is in fluid communication with port 24, while second chamber 29 is in fluid communication with ports 22. Lower baffle 33 includes a partition 41 that divides a portion of an interior volume of plenum assembly 19 into independent second and third chambers 39, 43 (FIG. 2). Third chamber 43 is in fluid communication with port 26.

Referring again to FIG. 1, the present invention also comprises a single duct channel 51 for selectively distributing air flow to the three chambers 37, 39, 43. In the fabrication of the embodiment shown, a plate 53 is secured to channel 51 to form a hollow, three-dimensional structure through which air flow is directed. A blower end 55 of channel 51 is positioned adjacent outlet 13 of blower 11, and a chamber end 57 positioned adjacent the entrances to the chambers 37, 39, 43. A single pivot edge 59 of channel 51 is pivotally mounted to a flange 61, which is attached to the mount plate 15 just below its aperture 17. Channel 51 is pivoted about edge 59 to distribute air flow to one or more of the various chambers 37, 39, 43.

In addition, the plenum assembly 19 further comprises a movable door 63 for ensuring that air flow from blower 11 enters the channel 51. The door 63 is pivotally mounted to mount plate 15 at edge 65 just above its aperture 17. As will be described in greater detail below, the door 63 is spring-biased to maintain sliding contact with an inner surface of channel 51.

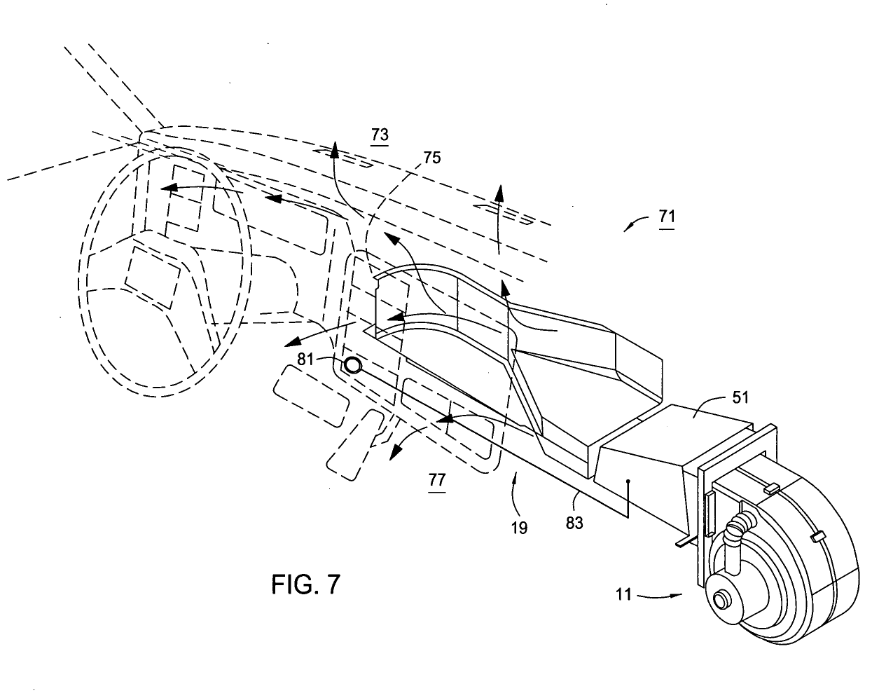

In operation (FIG. 7), the present invention is installed in an automobile vehicle 71 to direct air flow to various portions of the vehicle 71, such as the windshield 73 (e.g., for defrosting), the dashboard vents 75 (e.g., for air conditioning and heating), and the floor 77 (e.g., for heating). The air flow is manipulated by the present invention via, for example, a driver-accessible mechanical switch 81 (e.g., a control lever or rotary switch) and a flexible push/pull cable 83 to manually move channel 51 to various positions. The position of the channel 51 is proportional to the position of the switch 81. Automated systems such as, for example, those employing a potentiometer that is electrically connected to an electrical servo motor for automatically positioning the channel 51, and other systems such as those commonly known to one skilled in the art, also may be utilized to move channel 51.

For example, as shown in FIG. 2, channel 51 has a first position wherein it is substantially aligned with the first chamber 37 to defrost the windshield 73. In the first position, air flow from blower 11 exits outlet 13, travels through aperture 17 in mount plate 15, and enters channel 51 through blower end 55. The channel 51 is oriented or pivoted upward from horizontal at an angle of approximately 20°. In the first position of FIG. 2, the air flow is directed past chamber end 57 and into the first chamber 37, before distribution through port 24 to the adjacent windshield 73.

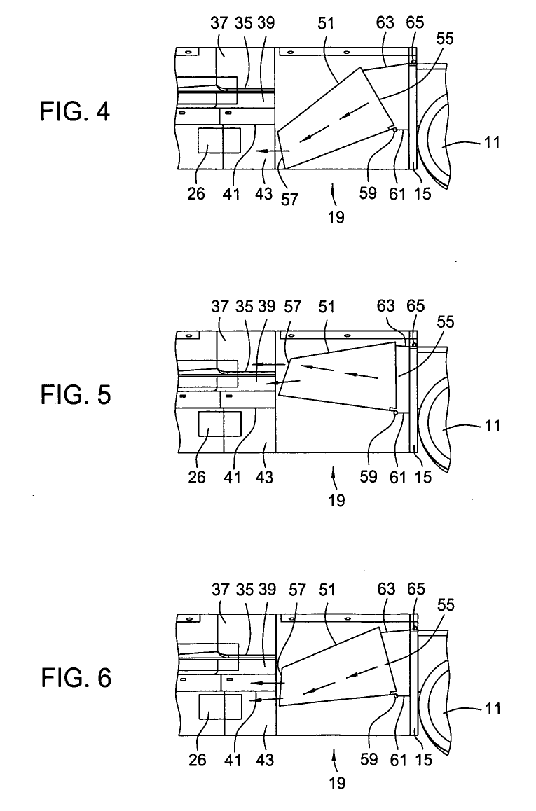

In the second position of FIG. 3, channel 51 is substantially aligned with the second chamber 39, such that channel 51 is horizontally level at 0°. In the embodiment shown, flange 61 is approximately in-plane with wall 41. The air flow is directed into the second chamber 39 before distribution through ports 22. In the third position of FIG. 4, channel 51 is pivoted downward at an angle of approximately 20° to horizontal. FIGS. 5 and 6 illustrate alternate intermediate positions wherein channel 51 is oriented at +/−10° to horizontal, respectively. In these fourth and fifth positions, air flow is distributed to both the first and second chambers 37, 39, and to the second and third chambers 39, 43, respectively.

The present invention also comprises a method of distributing ventilation in an automotive vehicle. In one embodiment the method comprises providing an air conditioning and heating ventilation system; circulating air flow through a plenum having independent windshield, dashboard, and floor chambers, and a single duct channel; pivoting only the single duct channel to selectively distribute the air flow to the chambers; defrosting a windshield of the automotive vehicle by pivoting the single duct channel toward the windshield chamber; ventilating the automotive vehicle by pivoting the single duct channel toward the dashboard chamber; and directing air flow toward a floor of the automotive vehicle by pivoting the single duct channel toward the floor chamber.

The method also may comprise providing the single duct channel as a hollow, three-dimensional enclosure, and further comprising a door positioned adjacent the single duct channel, the door being pivotally movable relative to the single duct channel for limiting the air flow from a blower into the single duct channel, the door being spring-biased to maintain contact with an interior of the single duct channel.

The method may further comprise both defrosting and ventilating the automotive vehicle by directing the air flow with only the single duct channel into both the windshield and dashboard chambers, and ventilating the automotive vehicle by directing the air flow with only the single duct channel into both the dashboard and floor chambers. In addition, the method may comprise pivoting the single duct channel approximately +/−20 degrees, respectively, relative to horizontal, and pivoting the single duct channel approximately +/−10 degrees, respectively, to divide the air flow between both the windshield and dashboard chambers, and the dashboard and floor chambers, respectively.

The present invention has several advantages, including the ability to reliably simplify the distribution of air flow in an automotive vehicle. This design only utilizes one moving part to redirect the air flow from blower. The hollow duct channel pivots along one edge to direct air flow in almost any direction within the vehicle.

While the invention has been shown or described in only some of its forms, it should be apparent to those skilled in the art that it is not so limited, but is susceptible to various changes without departing from the scope of the invention.

What is claimed is:

1. A ventilation distribution system, comprising:
a plenum having a first chamber, a second chamber, and a third chamber, each of the chambers being independent from the others;
a blower positioned adjacent the plenum for circulating an air flow; and
a single duct channel positioned between the plenum and the blower for selectively directing all of the air flow from the blower to one or more of the chambers.

2. A ventilation distribution system according to claim 1, wherein the single duct channel is a hollow, three-dimensional enclosure having a blower end for receiving the air flow from the blower, and a chamber end for releasing the air flow to the chambers.

3. A ventilation distribution system according to claim 1, wherein the single duct channel has a single pivot edge about which it is pivoted to distribute the air flow to the chambers.

4. A ventilation distribution system according to claim 1, further comprising a door positioned adjacent the single duct channel, the door being pivotally movable relative to the single duct channel for limiting the air flow from the blower into the single duct channel.

5. A ventilation distribution system according to claim 4, wherein the door is spring-biased to maintain contact with an interior of the single duct channel.

6. A ventilation distribution system according to claim 1, wherein the single duct channel is manipulated by a control selected from the group consisting of a mechanical switch having a cable connected to the single duct channel for manually adjusting the single duct channel, and a potentiometer electrically connected to an electrical servo motor for automated positioning of the single duct channel.

7. A ventilation distribution system according to claim 1, wherein the first, second, and third chambers comprise a windshield chamber, a dashboard chamber, and a floor chamber, respectively.

8. A ventilation distribution system according to claim 1, wherein the single duct channel has five positions comprising a first position wherein all air flow is directed into the first chamber, a second position wherein all air flow is directed into the second chamber, a third position wherein all air flow is directed into the third chamber, a fourth position wherein the air flow is divided and directed into both the first and second chambers, and a fifth position wherein the air flow is divided and directed into both the second and third chambers.

9. A ventilation distribution system according to claim 1, wherein the first, second, and third chambers are divided by two walls, the plenum has an internal flange that is aligned with the wall separating the second and third chambers, and the single duct channel is mounted to the internal flange inside the plenum.

10. A ventilation distribution system according to claim 9, wherein the single duct channel is rotated approximately 20 degrees in one direction to direct the air flow to the first chamber, and the single duct channel is rotated approximately 20 degrees in an opposite direction to direct the air flow to the third chamber.

11. A ventilation distribution system according to claim 10, wherein the single duct channel is rotated approximately 10 degrees in said one direction to divide and direct the air flow to both the first and second chambers, and the single duct channel is rotated approximately 10 degrees in said opposite direction to divide and direct the air flow to both the second and third chambers.

12. A plenum for a ventilation distribution system, comprising:
a body having a first chamber, a second chamber, and a third chamber, each of the chambers being independent from the others;
a blower positioned adjacent the plenum for circulating an air flow; and
a single duct channel positioned between the plenum and the blower for selectively directing the air flow from the blower to one or more of the chambers, the single duct channel comprising a hollow, three-dimensional enclosure having a blower end for receiving the air flow from the blower, a single pivot edge about which it is pivoted, and a chamber end for releasing the air flow to the chambers.

13. A plenum according to claim 12, further comprising a door positioned adjacent the single duct channel, the door being pivotally movable relative to the single duct channel for limiting the air flow from the blower into the single duct channel, the door being spring-biased to maintain contact with an interior of the single duct channel.

14. A plenum according to claim 12, wherein:
the single duct channel is manipulated by a control selected from the group consisting of a mechanical switch having a cable connected to the single duct channel for manually adjusting the single duct channel, and a potentiometer electrically connected to an electrical servo motor for automated positioning of the single duct channel; and
the first, second, and third chambers comprise a windshield chamber, a dashboard chamber, and a floor chamber, respectively.

15. A plenum according to claim 12, wherein the single duct channel has five positions comprising a first position wherein all air flow is directed into the first chamber, a second position wherein all air flow is directed into the second chamber, a third position wherein all air flow is directed into the third chamber, a fourth position wherein the air flow is divided and directed into both the first and second chambers, and a fifth position wherein the air flow is divided and directed into both the second and third chambers.

16. A plenum according to claim 12, wherein the first, second, and third chambers are divided by two walls, the plenum has an internal flange that is aligned with the wall separating the second and third chambers, and the single duct channel is mounted to the internal flange inside the plenum.

17. A plenum according to claim 12, wherein:
the single duct channel is rotated approximately 20 degrees in one direction to direct the air flow to the first chamber, and the single duct channel is rotated approximately 20 degrees in an opposite direction to direct the air flow to the third chamber; and
the single duct channel is rotated approximately 10 degrees in said one direction to divide and direct the air flow to both the first and second chambers, and the single duct channel is rotated approximately 10 degrees in said opposite direction to divide and direct the air flow to both the second and third chambers.

18. A method of distributing ventilation in an automotive vehicle, comprising:
(a) providing an air conditioning and heating ventilation system;
(b) circulating air flow through a plenum having independent windshield, dashboard, and floor chambers, and a single duct channel;
(c) pivoting only the single duct channel to selectively distribute the air flow to the chambers;
(d) defrosting a windshield of the automotive vehicle by pivoting the single duct channel toward the windshield chamber;
(e) ventilating the automotive vehicle by pivoting the single duct channel toward the dashboard chamber; and
(f) directing air flow toward a floor of the automotive vehicle by pivoting the single duct channel toward the floor chamber.

19. A method according to claim 18, wherein step (b) comprises providing the single duct channel as a hollow, three-dimensional enclosure, and further comprising a door positioned adjacent the single duct channel, the door being pivotally movable relative to the single duct channel for limiting the air flow from a blower into the single duct channel, the door being spring-biased to maintain contact with an interior of the single duct channel.

20. A method according to claim 18, further comprising both defrosting and ventilating the automotive vehicle by directing the air flow with only the single duct channel into both the windshield and dashboard chambers, and ventilating the automotive vehicle by directing the air flow with only the single duct channel into both the dashboard and floor chambers.

21. A method according to claim 20, wherein steps (d) and (f) comprise pivoting the single duct channel approximately +/−20 degrees, respectively, relative to horizontal, and pivoting the single duct channel approximately +/−10 degrees, respectively, to divide the air flow between both the windshield and dashboard chambers, and the dashboard and floor chambers, respectively.
